(19) United States
(12) Patent Application Publication
(10) Pub. No.: US 2024/0286617 A1
(43) Pub. Date: Aug. 29, 2024

(54) SCHOOL BUS DETECTION AND RESPONSE

(71) Applicant: GM Cruise Holdings LLC, San Francisco, CA (US)

(72) Inventors: Raghid Mardini, Oakland, CA (US); Pei Xu, Sherman Oaks, CA (US); Katelyn Wolfenberger, San Francisco, CA (US); Gweltaz Lever, San Francisco, CA (US); Rakesh Jasti, San Francisco, CA (US); Sasanka Nagavalli, Cupertino, CA (US); Shuhan Yang, Chandler, AZ (US); Qirui Wu, Philadelphia, PA (US)

(21) Appl. No.: 18/174,550

(22) Filed: Feb. 24, 2023

(51) Int. Cl. B60W 40/04; B60W 60/00; G06V 20/56; G06V 20/58

(52) U.S. Cl. CPC B60W 40/04; B60W 60/001; G06V 20/582; G06V 20/584; G06V 20/588; B60W 2554/402; B60W 2554/4046; B60W 2554/80

(57) ABSTRACT

Systems and techniques are provided for school bus detection and response by a vehicle such as an autonomous vehicle. An example method can include receiving sensor data collected by one or more sensors of a vehicle while the vehicle is in a scene. The sensor data can provide information about a school bus in the scene. The example method can include, based on the sensor data, determining a status of one or more lights of the school bus to determine a state of the school bus; determining that the one or more lights indicate whether the school bus is loading or unloading passengers; determining a behavior of one or more vehicles in the scene with respect to the school bus based on one or more parameters; and determining a behavior of the vehicle with respect to the school bus and the one or more vehicles.

### BACKGROUND

### 1. Technical Field

The present disclosure generally relates to school bus detection and response systems and, more specifically, techniques and systems for enabling autonomous vehicles to detect a school bus and understand the surrounding scene in relation to the school bus.

### 2. Introduction

An autonomous vehicle is a motorized vehicle that can navigate without a human driver. An exemplary autonomous vehicle can include various sensors, such as a camera sensor, a light detection and ranging (LiDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous navigation and routing operations, according to some examples of the present disclosure;

FIG. 2 illustrates a diagram illustrating an example school bus detection and response by an autonomous vehicle, according to some examples of the present disclosure;

FIG. 3 illustrates a diagram illustrating an example school bus detection and response by an autonomous vehicle near multiple vehicles, according to some examples of the present disclosure;

FIG. 4 is a flowchart illustrating an example process for school bus detection and response, according to some examples of the present disclosure;

FIG. 5 illustrates an example of a deep learning neural network that can be configured to detect a school bus and determine a status of the school bus, according to some aspects of the disclosed technology; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LiDAR) sensor, a radio detection and ranging (RADAR) sensor, an inertial measurement unit (IMU), an acoustic sensor (e.g., sound navigation and ranging (SONAR), microphone, etc.), and/or a global navigation satellite system (GNSS) and/or global positioning system (GPS) receiver, amongst others. The sensors can collect sensor data that measures, describes, and/or depicts one or more aspects of a target such as an object, a scene, a person and/or any other targets that may be present in the AV's surrounding environment. For example, the sensors of the AVs can collect and provide sensor data to an internal computing system of the AV, which can use for operations such as perception (e.g., object detection, event detection, tracking, localization, point cloud processing, image processing, etc.), planning (e.g., route planning, trajectory planning, situation analysis, behavioral and/or action planning, etc.), control (e.g., steering, braking, throttling, etc.), and prediction (e.g., motion prediction, behavior prediction, etc.).

School buses are one of the most regulated vehicles on the road as they are responsible for transporting children. To ensure safety, school buses are designed so that they are highly visible and include safety features such as flashing lights, cross-view mirrors, and stop-sign arms. For example, school buses are equipped with a flashing light system to alert road users (e.g., other drivers, pedestrians, etc.) when the bus is stopped to load and/or unload passengers. The flashing light system can be used to indicate that the school bus is in operation, which is a reminder for other drivers to drive with caution around the school bus. For example, the flashing light system (e.g., eight-way light system) may include red and yellow traffic lights placed at an elevated location of the school bus (e.g., at the roof or within a proximity to the roof), front and rear, both left and right sides of the school bus. When the flashing light system of a school bus is activated (e.g., when the red or yellow lights are flashing), vehicles around the school bus must follow certain signaling protocols, for example, stopping behind, in front of, or on the side of the school bus, preparing to stop behind the school bus, not passing the bus, and so on.

As such, in addition to correctly detecting and identifying a school bus, it is important for an AV to understand the status of the school bus (e.g., the status of the flashing lights, or whether the flashing light system is active or inactive) and the surrounding environment so that the AV can react appropriately and control the AV in an appropriate and effective manner around the school buses.

Described herein are systems, apparatuses, processes (also referred to as methods), and computer-readable media (collectively referred to as “systems and techniques”) for school bus detection and response by an AV. In some examples, the systems and techniques described herein can enable an AV to detect a school bus and determine whether the flashing light system of the school bus is active (e.g., on or activated) or inactive (e.g., off or deactivated). As used herein, when referring to an active state of a school bus, the terms “active state” mean that the school bus is loading and/or unloading one or more passengers or stopped to load and/or unload one or more passengers. As used herein, when referring to an inactive state of a school bus, the terms “inactive state” mean that the school bus is not loading and/or unloading one or more passengers or stopped to load and/or unload one or more passengers. Also, the systems and techniques described herein can identify one or more vehicles that are located within proximity to a school bus and determine the behavior of the vehicle(s) with respect to the school bus. For example, the systems and techniques can reason about the behavior of the vehicle(s) within the context of the school bus (e.g., whether the vehicle(s) is stopped or waiting behind a school bus of which the flashing light system is activated or the vehicle(s) is stopped irrespective of the status of the flashing light system of the school bus (e.g., to park)). The systems and techniques described herein can determine an appropriate response/behavior of the AV given the status of the school bus. In some examples, the systems and techniques described herein can also determine an appropriate response of the AV to other vehicles in the scene in the context of a school bus.

The AVs implementing the systems and techniques described herein can determine how to respond or behave with respect to a school bus based on one or more factors so that the AVs can react and behave accordingly in an appropriate and effective manner relative to the school bus. Non-limiting examples of the one or more factors can include a flashing light status of the school bus (e.g., a light flashing in a particular color (e.g., yellow or red), a static light of a particular color emitted by one or more light systems of the school bus, a light pattern of a light system of the school bus, etc.), a status of a signaling device of the school bus (e.g., an extended stop sign device, a protracted stop sign device, etc.), one or more environmental factors (e.g., weather, scene elements, etc.), one or more contextual factors (e.g., traffic conditions, a behavior of the school bus, a behavior of one or more vehicles in the scene, a behavior and/or instruction of a human traffic controller, an activity and/or event associated with a scene, etc.), one or more operational and/or functional factors, one or more applicable regulations, safety factors, and/or any other factors.

In some examples, while an AV is navigating through a scene, one or more sensor systems of the AV can collect sensor data (e.g., data from one or more camera sensors, data from one or more LiDAR sensors, data from one or more RADAR sensors, data from one or more acoustic sensors (e.g., ultrasonic sensors, microphones, etc.), data from one or more infrared (IR) sensors, etc.) that measures objects (and/or attributes thereof) in the environment and/or is descriptive of objects in the environment. For example, a perception system of the AV can use the sensor data to detect a school bus and/or any attributes associated with the school bus (e.g., physical properties of the school bus such as size, dimensions, color, etc.). Further, the perception system can use the sensor data to determine the status of the school bus based on one or more factors perceived based on the sensor data such as, for example, whether a light system mounted on the school bus (e.g., a light system used by the school bus to convey status information) is on, off, or unknown; the status of the light system mounted on the school bus; a status and/or behavior of other vehicles in the scene; a signal and/or instruction from a human traffic controller, one or more other cues in the scene (e.g., a traffic light status, an environmental factor, a context, etc.); and/or any other factors. For example, if a light system of a school bus is on (e.g., emitting or flashing red and/or yellow light), the status of the school bus can be classified as active. If the light system is off (e.g., not emitting or flashing red and/or yellow light), the status of the school bus can be classified as inactive. The AV can determine a particular behavior/response to the school bus based on the classification of the light system. In some aspects, the status of the school bus can be classified as unknown if the status of the flashing light system cannot be determined due to, for example, an obstructed view of the flashing light system, malfunctioning of the flashing light system, etc.

In some aspects, the AVs implementing the systems and techniques described herein can use contextual information to determine the status of the school bus. The contextual information can be based on the sensor data collected by the sensor system(s) of the AVs and/or any other available data (e.g., map data, traffic data, a signal/instruction from a human traffic controller, etc.) that is associated with the scene or the environment associated with the school bus. Examples of contextual information can include, without limitation, road features (e.g., traffic signs, curbs, sidewalks, etc.), lane geometries, a presence of one or more passengers (e.g., children) within a threshold proximity to the school bus, semantic features detected from the sensor data, environment features, etc. In some examples, when the status of the school bus is unknown, contextual information can be used to determine whether the status of the school bus (or the flashing light system) is active or inactive. For example, when a portion of the light system of a school bus is obstructed and the status of the school bus cannot be determined from the light system, the AV can use other contextual information indicating that children are getting on or off the school bus, a detection that a stop-sign arm of the school bus is extended outward (e.g., relative to the school bus) can indicate that the status of the school bus (or the light system) is active, a behavior of other vehicles and/or road users in the scene can indicate a status of the school bus, etc.

In some cases, the A Vs implementing the systems and techniques described herein can identify one or more vehicles located within proximity of the school bus based on the sensor data collected by the sensor(s) of the AV. For example, a perception stack of an AV can detect one or more vehicles located within proximity of the school bus (e.g., located between the school bus and the AV). The perception stack of the AV can detect and recognize (e.g., based on the sensor data) a status and/or behavior of the one or more vehicles, which the AV can use to determine a status of the school bus that may have prompted/triggered such status and/or behavior of the one or more vehicles. In some cases, the vehicle(s) may have stopped in response to a school bus that is active (e.g., loading or unloading passengers). In other cases, the vehicle(s) may have stopped or parked irrespective of the status of the school bus. The systems and techniques described herein can determine a behavior of the vehicle(s) located within proximity of the school bus based on one or more parameters such as a distance between the school bus and the vehicle(s), a distance between the vehicle(s) and a curb, a presence of parking signs, etc., and use the behavior of the vehicle(s) to determine a status of the school bus. For example, if the distance between the school bus and the vehicle(s) is below a threshold (e.g., a predetermined threshold distance) and the vehicle(s) is in a particular state (e.g., stopped), the AV can be determined that the vehicle(s) are stopped for the active school bus. If the distance between the vehicle(s) and a curb is below a threshold (e.g., a predetermined threshold distance) and the vehicle(s) is in a particular state (e.g., stopped), the AV can be determined that the vehicle(s) are stopped to park in an area associated with the curb.

Moreover, AVs can be controlled through software stacks that implement machine learning techniques to control the AVs based on sensor data that is captured during operations of the AVs. In some examples, AVs implementing the systems and techniques described herein can use machine learning algorithms to detect a school bus based on sensor data as further described herein. For example, a machine learning model can be trained to detect and recognize a school bus. Sensor data (e.g., image data captured by a camera mounted on an AV) can be fed into a machine learning model that can interpret the gathered sensor data to detect and recognize a school bus based on the sensor data. Further, the machine learning algorithms can determine whether the school bus is active or inactive (e.g., whether the flashing light system of the school bus is active, inactive, or unknown) based on input sensor data.

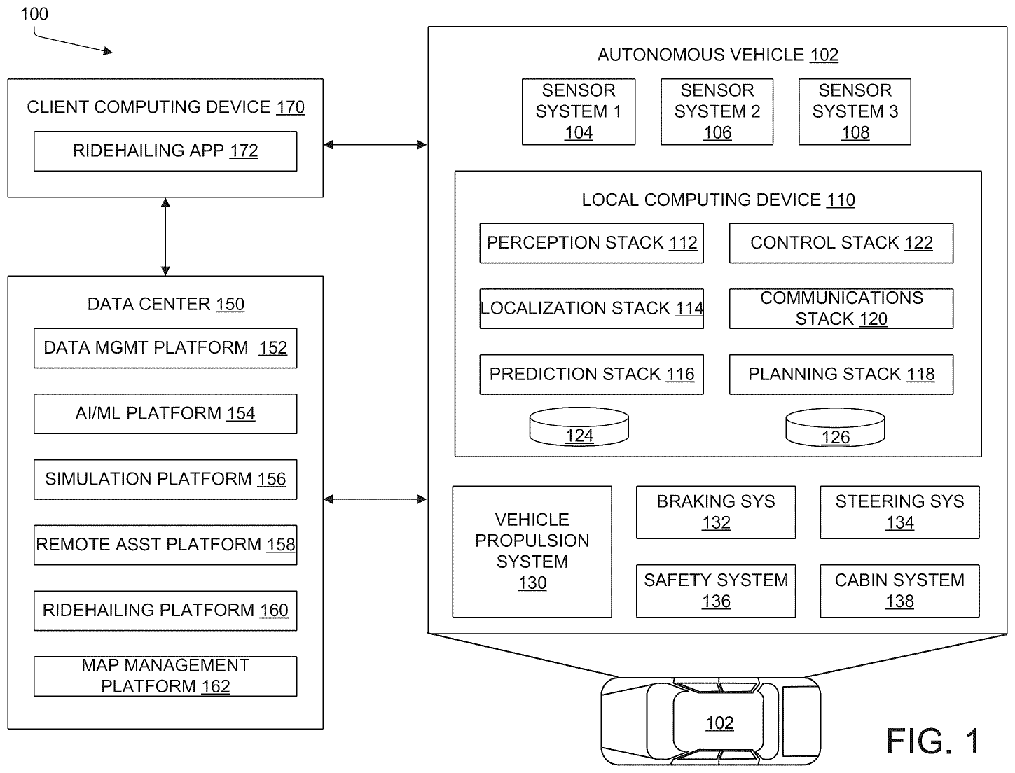

Examples of the systems and techniques described herein are illustrated in FIG. 1 through FIG. 6 and described below.

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 to enable passengers to view the AV 102 in transit en route to a pick-up or drop-off location, and so on.

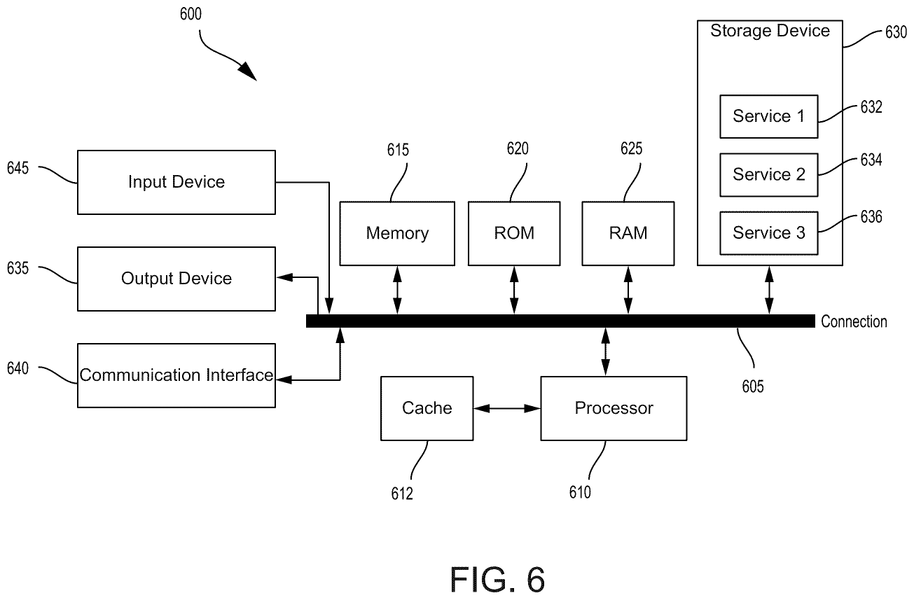

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

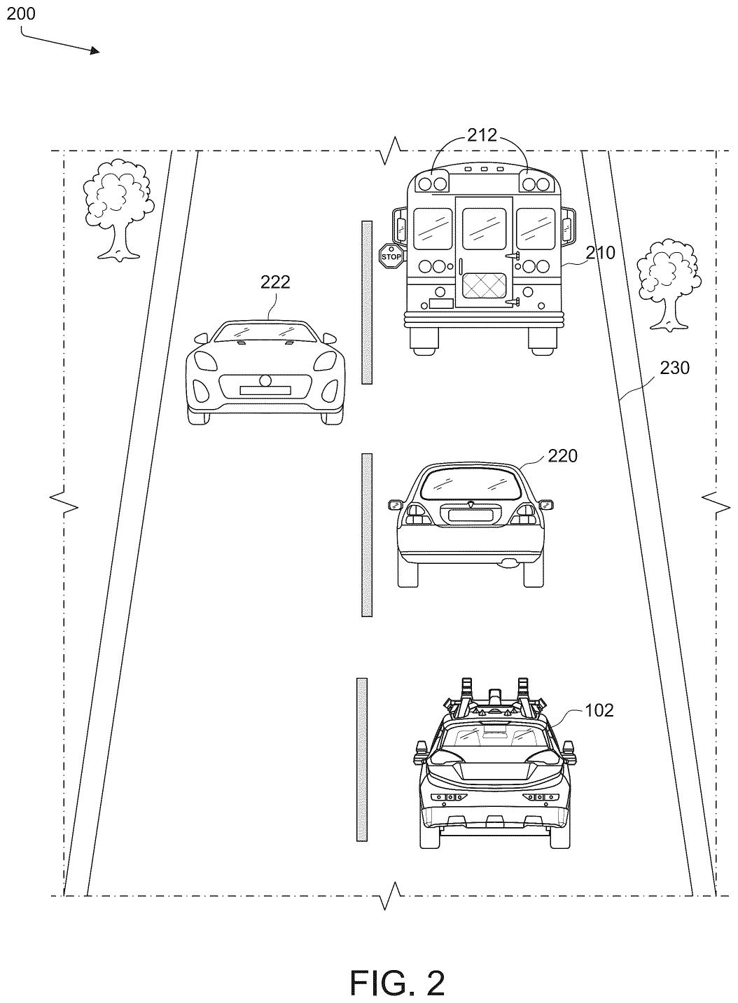

FIG. 2 illustrates a diagram illustrating an example scenario 200 of a school bus detection (e.g., identification and recognition) and response by an AV. In this example, scenario 200 includes an AV 102, a school bus 210 located in front of the AV 102 and in the same lane as the AV 102, a first vehicle 220 located between the school bus 210 and the AV 102 in the same lane, and a second vehicle 222 located on the left side of the school bus 210 on another lane relative to the lane of the AV 102, the school bus 210, and the first vehicle 220 (e.g., a left lane). As previously described, various sensor systems (e.g., sensor systems 104-108 as illustrated in FIG. 1) of the AV 102 can collect sensor data that measures, describes, and/or depicts the scene including the school bus 210, the first vehicle 220, the second vehicle 222, and the surrounding environment.

In some aspects, the sensor data collected by the AV 102 can include information about the school bus 210 in the scene (e.g., the school bus 210 itself and/or one or more attributes associated with the school bus 210). The sensor data relating to the school bus 210 can provide information relating to a semantic meaning of school bus 210 and/or attributes or properties of the school bus 210 such as size, dimensions, color, shape, etc. In some examples, the sensor data can include information relating to a light system 212 mounted on the school bus 210 and used by the school bus 210 to communicate a status of the school bus 210 to others in the scene. For example, the school bus 210 is equipped with a light system 212, which can be used to provide an alert to others in the scene of a status of the school bus 210 (e.g., the status with respect to loading or unloading one or more people and/or predicted passengers (e.g., children)). The alert may be tailored with signaling protocols that have specific meanings, such as “stop,” “prepare to stop,” “do not pass,” “pass,” etc.

In some aspects, the light system 212 of the school bus 210 includes a light system configured to emit and/or flash lights (e.g., red and yellow lights, etc.) that is mounted on the front (or relative to the front) of the school bus 210, and/or a light system configured to emit and/or flash the lights that is mounted on the rear (or relative to the rear) of the school bus 210 (e.g., and at or relative to an upper portion of the school bus 210). In some examples, the sensor data can reflect the status of one or more lights of the light system 212. For example, the sensor data can indicate the status of the light system 212 of the school bus 210 such as whether a red and/or yellow light is/are being emitted (e.g., statically or in a pattern such as flashing) by the light system 212. The light system 212 can be used to indicate the status of the school bus 210. Thus, the AV 102 can use the sensor data to determine a status of the school bus 210 based on a status of the light system 212. The AV 102 can adjust its position and/or behavior as needed/appropriate based on the status of the school bus 210 per one or more associated signaling protocols. For example, a yellow flashing light can indicate that the school bus 210 is preparing to stop to load or unload children. As follows, the AV 102 may stop or prepare to stop if it determines that the school bus 210 is in front of the AV 102 in the same lane and the light system 212 is emitting/depicting a yellow flashing light. A red flashing light can indicate that the school bus 210 has stopped and passengers (e.g., children, etc.) are getting on the school bus 210 or off the school bus 210. As follows, the AV 102 may stop and wait behind the school bus 210 until the red light stops flashing. Once the school bus 210 begins moving and/or the status of the light system 212 changes to a particular state (e.g., stopping emitting/flashing a light), the AV 102 can resume navigating.

In some cases, image data captured over multiple periods of time (e.g., seconds) by a sensor(s) of the AV 102 (e.g., sensor systems 104-108) can be used by the AV 102 to determine whether the light system 212 is activated (e.g., whether a particular light such as a red and/or yellow light of the light system 212 is being emitted and/or flashing). For example, an image of the light system 212 can be captured by a camera sensor of the AV 102 over multiple seconds to determine whether a certain light(s) of the light system 212, such as a red and/or yellow light, is/are being emitted and/or is/are flashing. The AV 102 can perform image processing to detect and/or recognize the status of the light system 212 based on the images captured by the camera sensor. In some examples, the AV 102 can use the images (and/or other sensor data) to detect and recognize the school bus 210 (and/or an associated behavior) in the scene. In some examples, the detection of the school bus 210 and the determination of the status of the school bus 210 (e.g., light system 212) can be done simultaneously (or otherwise) based on the sensor data that is descriptive of the light system 212.

In some aspects, the AV 102 can use contextual information based on the sensor data (and, in some cases, based on additional data) to determine the status of the school bus 210 (or the light system 212). In some cases, contextual information can include semantic information about the school bus 210 and/or the environment in relation to the school bus 210 and/or the AV 102. Semantic information can include, for example, semantic map information that describes characteristics of geometric delineations (e.g., a lane geometry of a lane in the scene), landmarks, physical regions surrounding the school bus 210 and/or the AV 102, road features (e.g., traffic signs, curbs, sidewalks, etc.), lane geometries, a presence of one or more passengers (e.g., children) within a threshold proximity to the school bus, information about one or more traffic signals (e.g., a traffic light, a stop sign, etc.), etc. In some cases, the AV 102 can use such contextual information in addition to or in lieu of information about the light system 212. For example, if the status of the school bus cannot be determined based on the light system 212 due to an obstructed view of the sensor(s) of the AV 102 to the school bus 210 (and/or a portion(s) thereof) and/or any other reasons, contextual information can be used to determine the status of the school bus 210 (e.g., whether the school bus 210 is about to or is stopping to load and/or unload passengers, whether the school bus 210 is resuming navigation, etc.). In some examples, the presence of one or more passengers (e.g., children) getting on or off the school bus 210 can indicate that the school bus 210 (or the light system 212) is active and the AV 102 should stop and avoid passing the school bus 210. In some cases, traffic signs such as school zone, school zone crossing, school bus stop ahead, student drop-off, children crossing, traffic lights, and so on can indicate the high likelihood of an active school bus 210 (or an active light system 212). In some examples, if a stop-sign device (e.g., arm) mounted on the school bus 210 is activated (e.g., extended outward relative to the school bus 210), the AV 102 can determine that it is highly likely that the school bus 210 is loading/unloading passengers and/or the light system 212 is active. In some cases, having a stop-sign device (e.g., arm) mounted on the school bus 210 activated indicates the highest likelihood that the school bus 210 is active as the stop-sign device (e.g., arm) may be activated in conjunction with an active light system 212.

Additionally or alternatively, the AV 102 can determine, based on the sensor data, the relative position of the school bus 210 (e.g., relative to the AV 102 and/or other scene elements such as other vehicles, traffic signals, landmarks, etc.) and/or a pose of the AV 102 in relation to the school bus 210, so as to not unduly re-direct or stop the AV 102 in response to an active school bus (e.g., a school bus loading/unloading passengers or preparing to load/unload passengers). For example, in some cases depending on local rules, if an active school bus is detected on another lane relative to the AV 102 or another side of the road relative to a lane of the AV 102, the AV 102 may determine that it does not need to stop. In some examples, the relative position of the school bus 210 (e.g., relative to the AV 102 and/or other scene elements) can be used to determine the status of the light system 212. For example, if the AV 102 is located at a particular location/position relative to the school bus 210 (e.g., adjacent and/or parallel to the school bus 210), the AV 102 may determine that it is likely that the sensors of the AV 102 do not have a clear view of the light system 212 (e.g., the light system 212 is not within the field-of-view of the sensors of the AV 102) that is mounted on the front and/or rear of the school bus 210 and cannot collect enough information to detect a state of the light system 212. In such cases, the status of the light system 212 can be classified as unknown based on the relative position of the school bus 210 (and/or the light system 212 of the school bus 210) and the AV 102.

In some aspects, based on the status of the school bus 210, the AV 102 can determine and/or plan a response/behavior of the AV 102 with respect to the school bus 210. For example, depending on the status of the school bus 210 (e.g., the status of the light system 212), the AV 102 can implement plans for controlling the AV 102 accordingly. If the light system 212 is activated (and/or a particular light(s) of the light system 212 is activated), the AV 102 located behind the school bus 210 may stop and wait until the light system 212 (and/or the particular light(s) of the light system 212) is deactivated and/or a different light of the light system 212 is activated. In some examples, the AV 102 can determine a distance that needs to be maintained between the school bus 210 and the AV 102 and if the AV 102 needs to stop behind the school bus 210 (and/or a point at which the AV 102 needs to stop behind the school bus 210) to keep such distance between the school bus 210 when active and the AV 102 (e.g., 10 to 20 feet).

In some examples, the AV 102 can identify, based on the sensor data, one or more vehicles such as a first vehicle 220 and a second vehicle 222 that are located within proximity to the school bus 210. For example, in the example scenario 200, the first vehicle 220 is in front of the AV 102 and behind the school bus 210 in the same lane as the AV 102 and the school bus 210, and the second vehicle 222 is located near the school bus 210 in the other lane. The AV 102 can use sensor data collected by one or more sensors of the AV 102 (e.g., sensor systems 104-108) to detect the first vehicle 220 and/or the second vehicle 222, and/or determine a relative distance and/or position of the first vehicle 220 and the school bus 210 (and the AV 102) and the relative distance and/or position of the second vehicle 222 and the school bus 210 (and the AV 102). Moreover, the AV 102 can additionally or alternatively use information about a behavior of the first vehicle 220 and/or a behavior of the second vehicle 222 (e.g., as detected by the AV 102 based on sensor data) to predict a status of the school bus 210 and/or the light system 212. For example, the AV 102 can use information about the relative distance and/or position of the first vehicle 220, the relative distance and/or position of the second vehicle 222, and/or the behavior of the first vehicle 220 and/or the second vehicle 222 to predict a status of the school bus 210 and/or the light system 212 of the school bus 210. To illustrate, if the AV 102 determines (e.g., based on sensor data) that the first vehicle 220 is stopped (or stopping) and within a range of distances to the school bus 210, the AV 102 may determine that the first vehicle 220 is reacting to a change of status of the school bus 210 (e.g., stopping to load/unload passengers or preparing to stop to load/unload passengers) and thus use the information about the behavior of the first vehicle 220 and the distance of the first vehicle 220 to the school bus 210 to detect the change of status of the school bus 210.

In some cases, the AV 102 can determine a behavior of other vehicles that are located in proximity to the school bus 210 such as the first vehicle 220 and/or the second vehicle 222 with respect to the school bus 210. In some cases, the AV 102 can identify that the first vehicle 220 is stopped (or stopping) behind the school bus 210 and determine whether the first vehicle 220 is stopped behind the school bus 210 in response to a status of the school bus 210 (e.g., loading/unloading passengers) or whether the first vehicle 220 is parked irrespective of the status of the school bus 210. The AV 102 can determine a behavior to implement in response to the status of the school bus 210 as determined based on the first vehicle 220 as previously explained.

In some aspects, the AV 102 can determine the behavior of other vehicles that are located in the scene and/or within a proximity to the school bus 210 based on one or more parameters. Non-limiting examples of the parameter(s) can include the lane location of the vehicle, a distance between each of the vehicle(s) (e.g., the first vehicle 220 or the second vehicle 222) and the school bus 210, a distance between each of the vehicle(s) (e.g., the first vehicle 220 or the second vehicle 222) and a curb (e.g., curb 230) that is adjacent to the vehicle(s), and contextual and/or environmental factors.

In some examples, the AV 102 can determine, based on the sensor data, whether the first vehicle 220 or the second vehicle 222 is in the same lane as the school bus 210 or the AV 102. If the second vehicle 222 located within proximity to the school bus 210 is stopped in the other lane relative to the AV 102 and the school bus 210, the AV 102 can determine that it is likely that the second vehicle 222 is stopped or parked irrespective of the status of the school bus 210 as vehicles that are not in the same lane as an active school bus 210 may not need to stop for the school bus 210 in some jurisdictions.

In some aspects, the AV 102 can determine the distance between each of the vehicles (e.g., the first vehicle 220 or the second vehicle 222) and the school bus 210. In some cases, if the distance between the school bus 210 and a vehicle(s) located in a same lane as the school bus 210 (e.g., the first vehicle 220) is below a threshold distance or within a predetermined range (e.g., 0-25 meters), the AV 102 can infer that the vehicle(s) is/are stopped for the school bus 210 and the school bus 210 may be active (e.g., loading/unloading passengers) and/or the light system 212 of the school bus 210 is active. In some examples, the AV 102 can determine that the school bus 210 is active if the AV 102 determines (based on sensor data) that the first vehicle 220 is within a distance range of the school bus 210. The distance range may include a first distance that specifies a minimum distance between the first vehicle 220 and the school bus 210 and a maximum distance between the first vehicle 220 and the school bus 210. In some examples, if the first vehicle 220 is located less than the minimum distance to the school bus 210, the AV 102 may determine that the status and/or behavior of the first vehicle 220 is not responsive to or reflective of a state and/or behavior of the school bus 210 (e.g., the first vehicle 220 may be parked irrespective of a state of the school bus 210). Similarly, if the first vehicle 220 is located more than the maximum distance to the school bus 210, the AV 102 may determine that the status and/or behavior of the first vehicle 220 is not responsive to or reflective of a state and/or behavior of the school bus 210 (e.g., the first vehicle 220 may be acting or reacting irrespective of a state of the school bus 210).

For example, if the first vehicle 220 is stopped behind the school bus 210 and the school bus 210 has its light system 212 activated/on, the AV 102 can determine the distance between the first vehicle 220 and the school bus 210. If the distance between the first vehicle 220 and the school bus 210 is within the threshold range (e.g., 0-25 meters) or below a threshold distance, the AV 102 can determine that it is likely that the first vehicle 220 is stopped or waiting behind the school bus 210 in response to an active status of the school bus 210. In another example, if the distance between the first vehicle 220 and the school bus 210 exceeds the threshold distance or is outside of the threshold range, the AV 102 may determine that it is likely that the first vehicle 220 is stopped behind the school bus 210 irrespective of the status of the school bus 210 or for other reasons (e.g., to park).

In some cases, the AV 102 can determine the distance between each vehicle(s) (e.g., the first vehicle 220 or the second vehicle 222) and a curb (e.g., curb 230) adjacent to that vehicle. For example, if the first vehicle 220 is stopped behind the school bus 210 and the school bus 210 has its light system 212 activated/on, the AV 102 can determine the distance between the first vehicle 220 and the curb 230, which is adjacent to the first vehicle 220. If the distance between the first vehicle 220 and the curb 230 is below a threshold distance or within a threshold range (e.g., 0-0.5 meters), the AV 102 can determine that it is likely that the first vehicle 220 is parked adjacent to the curb 230 irrespective of the status of the school bus 210. If the distance between the first vehicle 220 and the curb 230 exceeds a threshold distance or is out of a threshold range (e.g., 0-0.5 meters), the AV 102 can determine that it is less likely that the first vehicle 220 is parked adjacent to the curb 230 and more likely that the first vehicle 220 is stopped behind the school bus 210 in response to the active status of the school bus 210.

In some examples, if the distance between the first vehicle 220 and the school bus 210 is within a threshold range or below a threshold value and the distance between the first vehicle 220 and the curb 230 is within a threshold range or below a threshold value, the AV 102 can determine that it is more likely that the first vehicle 220 is stopped behind the school bus 210 in response to the active status of the school bus 210. In some cases, the AV 102 can look at other factors (e.g., road features, scene features, other vehicles around the school bus 210, whether the first vehicle 220 has brake light(s) on, etc.), in addition to those two distances, that may indicate whether the first vehicle 220 is stopped behind the school bus 210 in response to the active status of the school bus 210 or parked adjacent to the curb 230. For example, if the first vehicle 220 has its brake lights on, the AV 102 can determine that the first vehicle 220 is stopped in response to the active status of the school bus 210.

In some examples, the AV 102 may apply respective weights to parameter(s) or parameter value(s) that can be used to determine the behavior of vehicle(s) located within proximity to a school bus, for example, whether the behavior of the vehicle(s) (e.g., the first vehicle 220) is in response to the status of the school bus 210 or irrespective of the status of the school bus 210. For example, the AV 102 may apply higher weights to certain parameters or parameter values that are more determinative of the behavior of the vehicle(s) (e.g., indicate a higher likelihood or a higher confidence) and lower weights to other parameters or parameter values that are less determinative of the behavior of the vehicle(s) (e.g., indicate a lower likelihood or a lower confidence). For example, the AV 102 may assign higher weights to a shorter distance between the first vehicle 220 and the school bus 210 in determining that the first vehicle 220 is stopped in response to an active state of the school bus 210. In another example, the AV 102 may assign lower weights to a longer distance between the first vehicle 220 and the school bus 210 in determining that the first vehicle 220 is stopped in response to an active state of the school bus 210. Additionally or alternatively, the AV 102 may assign higher weights to a shorter distance between the first vehicle 220 and the curb 230 in determining that the first vehicle 220 is stopped to park in an area associated with the curb 230. In another example, the AV 102 may assign lower weights to a longer distance between the first vehicle 220 and the curb 230 in determining that the first vehicle 220 is stopped to park in an area associated with the curb 230.

In some examples, if both the distance between the first vehicle 220 and the school bus 210 and the distance between the first vehicle 220 and the curb 230 fall within the respective threshold range, the AV 102 may apply different weights to the parameter values (e.g., the distances) for determining a state of the school bus 210 and/or the behavior of the first vehicle 220 in response to the state of the school bus 210. For example, if the first vehicle 220 is within one or more respective threshold proximities to both the school bus 210 and the curb 230, the AV 102 can apply respective weights to the distances for determining/reasoning the behavior of the first vehicle 220.

In some aspects, the AV 102 can determine or plan a response/behavior of the AV 102 based on the status of the school bus 210 and/or the behavior of the first vehicle 220. In some examples, if the AV 102 determines that the school bus 210 is active (e.g., is loading/unloading passengers) and/or the light system 212 is activated/on and the first vehicle 220 is stopped in response to an active state of the school bus 210, the AV 102 may determine to stop behind first vehicle 220 and wait until the school bus 210 or the first vehicle 220 starts moving. In other examples, if the AV 102 determines that the school bus 210 is active (e.g., the light system 212 is activated/on) and the first vehicle 220 is parked near the curb 230 irrespective of the status of the school bus 210, the AV 102 may determine the distance between the school bus 210 and the first vehicle 220 to determine if the AV 102 can pass the first vehicle 220 and stop between the school bus 210 and the first vehicle 220.

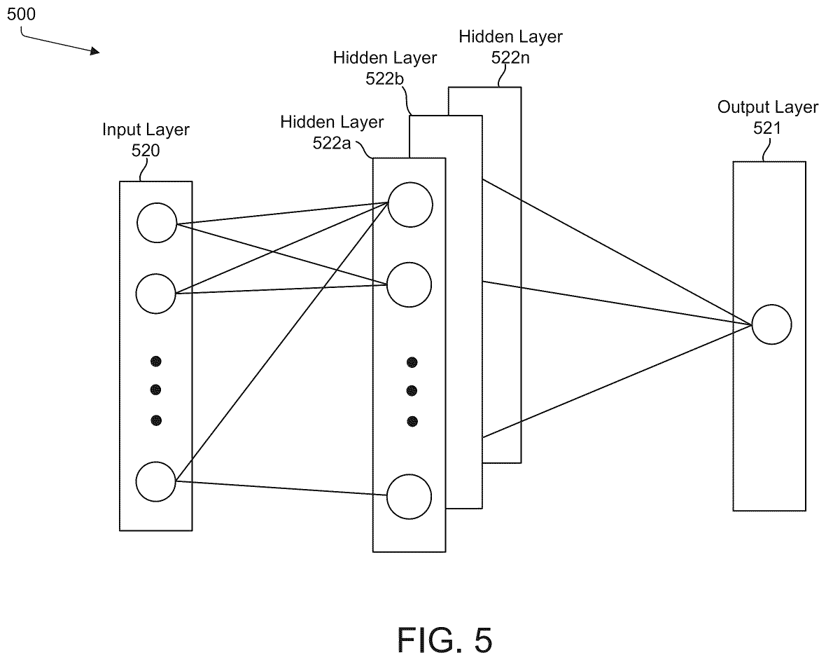

In some examples, the AV 102 may detect the school bus 210 located within proximity to the AV 102 (e.g., via local computing device 110 as illustrated in FIG. 1 or machine learning algorithm via deep learning neural network 500 as illustrated in FIG. 5). For example, the AV 102 may use one or more machine learning algorithms (e.g., via deep learning neural network 500 as illustrated in FIG. 5) to detect (e.g., identify and recognize) school bus 210 based on the sensor data collected by one or more sensors (e.g., sensor systems 104-108) of the AV 102.

In some examples, a determination of a status (e.g., active or inactive) of the school bus 210 and/or a behavior of the AV 102 relative to the school bus 210 can vary based on the pose of the school bus 210 relative to the AV 102. For examples, if the AV 102 determines (e.g., based on sensor data) that the school bus 210 is stopped or stopping on a road/lane that is perpendicular to a road/lane of the AV 102, the AV 102 may implement a different behavior and/or response to the school bus 210 than if the AV 102 determines that the school bus 210 is on a same road/lane as the AV 102 and/or traveling in a same direction as the AV 102. To illustrate, if the AV 102 detects that the school bus 210 is traveling on a road or lane in a direction that is perpendicular to a direction of a road or lane of the AV 102 (e.g., perpendicular to a direction of travel by the AV 102) and the school bus 210 is stopped or stopping within a proximity to an intersection that the AV 102 has reached or is approaching (e.g., within a threshold proximity), the AV 102 may determine that it can cross the intersection if it maintains the current direction of travel of the AV 102 (e.g., which is perpendicular to that of the school bus 210).

On the other hand, in this example, the AV 102 may determine that the AV 102 may need to wait until the school bus 210 is in an inactive state or the AV 102 verifies that the school bus 210 is in an inactive state before the AV 102 can turn in the intersection into a lane/road that is adjacent to the lane/road of the school bus 210 and has a directionality (e.g., direction of traffic) that is opposite to the directionality of the lane/road of the school bus 210. In other words, the AV 102 may determine that the AV 102 should not turn in the intersection to travel passed/around the school bus 210 in a lane/road that is adjacent to the lane/road of the school bus 210 unless the AV 102 determines that the school bus 210 is in an inactive state (e.g., is not loading or unloading passengers) and/or is able to verify that the school bus 210 is in an inactive state.

In some cases, the cues used by the AV 102 to determine a state/status of the school bus 210 can vary depending on the pose of the school bus 210 relative to the AV 102. For example, if the AV 102 is traveling on a same road or lane as the school bus 210 as shown in FIG. 2, the AV 102 may determine a state/status of the school bus 210 (e.g., using sensor data) based on a status of a light system 212 of the school bus 210 (e.g., based on a determination of a particular light(s) emitted by the light system 212 (e.g., a yellow light, a red light, etc.); a light pattern (e.g., flashing a light(s), a static light, a light emitted at a certain cadence, etc.) displayed by the light system 212; a lack of display of any light, any pattern of light, and/or a particular or predetermined light by the light system 212, etc.). However, if a position of the school bus 210 is perpendicular to a position of the AV 102 in the scene (e.g., if the school bus 210 is on a road/lane that is perpendicular to a road/lane of the AV 102), the light system 212 of the school bus 210 may not be within a field-of-view of any camera sensors of the AV 102. Therefore, the AV 102 may not be able to capture any image data depicting a status of the light system 212 and the AV 102 may not be able to determine the state/status of the school bus 210 based on the light system 212. In such cases, the AV 102 may use other cues in the scene to predict a state/status of the school bus 210.

For example, the AV 102 may determine the state/status of the school bus 210 based on a pose of the school bus 210 relative to one or more scene elements (e.g., relative to the AV 102, one or more other vehicles, one or more traffic signs or signals, relative to an intersection, relative to one or more lane/road boundaries, relative to a sidewalk, etc.) as detected based on sensor data, a behavior of the school bus 210 (e.g., stopped, moving, accelerating, decelerating, etc.) as detected based on sensor data, a behavior of one or more vehicles in the scene (e.g., stopped, moving, accelerating, decelerating, etc.) as detected based on sensor data, a pose of the one or more vehicles relative to the school bus 210 (e.g., behind the school bus 210 in a same lane/road as the school bus 210 and within a proximity or proximity range to the school bus 210, etc.) as detected based on sensor data, a location of the school bus 210 (e.g., within a proximity or a proximity range to an intersection or a yield location, beyond or outside of a proximity or proximity range to the intersection or yield location, at (or within a proximity to) a location on a road designated as a school bus stop and/or adjacent to an area containing school bus stop indicators (e.g., school bus stop markings, congregation of children and/or people, etc.), within a proximity to a curb adjacent to a lane/road of the school bus 210, etc.) as detected based on sensor data, a cue or instruction from a human traffic controller, a state of a stop indicator device of the school bus 210 (e.g., an extended state of an arm with a stop sign mounted on the school bus 210, a protracted state of the arm with the stop sign, etc.), and/or any other scene cues.

In some instances, the AV 102 may determine (e.g., via machine learning algorithms) whether the school bus 210 (or the light system 212 of the school bus 210) is active or inactive. For example, the AV 102 may perceive (e.g., via perception stack 112 as illustrated in FIG. 1) the presence of school bus 210 and determine the status of the school bus 210 (e.g., via machine learning algorithms as executed via a deep learning neural network 500 as illustrated in FIG. 5). In some examples, the AV 102 can use machine learning algorithms (e.g., via a deep learning neural network 500 as illustrated in FIG. 5) to determine or reason the behavior of one or more vehicle(s) (e.g., the first vehicle 220 or the second vehicle 222) within proximity to the school bus 210. In some examples, the machine learning algorithm(s) can be trained with data from road encounters of school buses and simulation data associated with school buses in various scenarios and scenes.

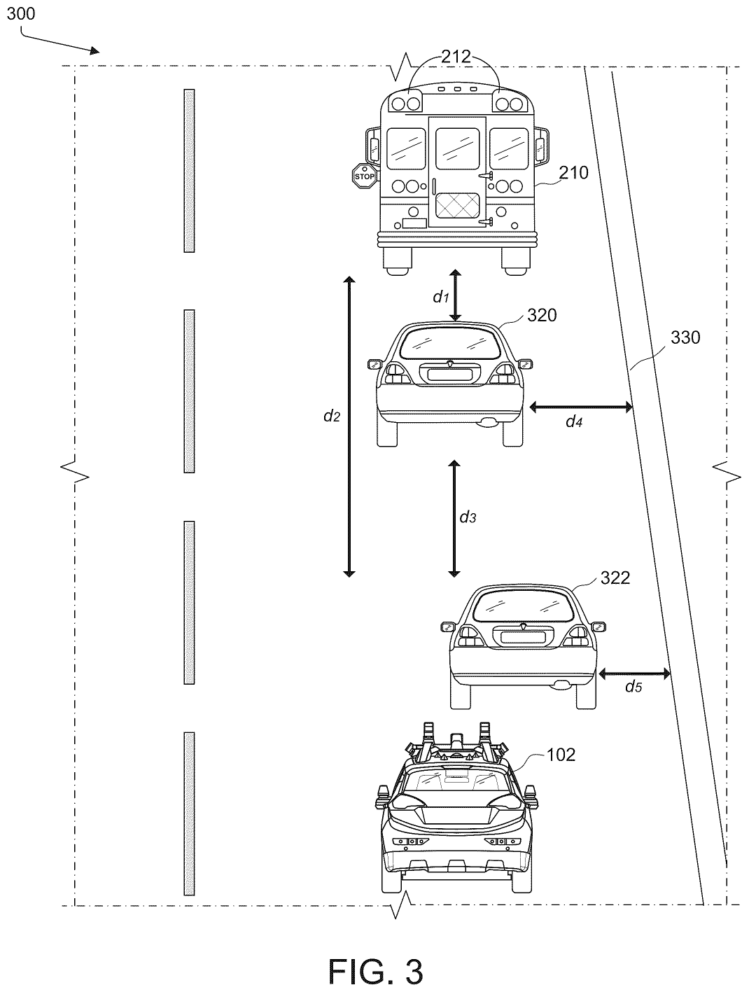

FIG. 3 illustrates a diagram illustrating an example scenario 300 of a school bus detection and response by an AV. In this example, scenario 300 includes an AV 102, a school bus 210 with a light system 212, a first vehicle 320, and a second vehicle 322, all of which are located in a same lane on a road in the scene. As previously described, various sensor systems (e.g., sensor systems 104-108 as illustrated in FIG. 1) of the AV 102 can collect sensor data that measures, describes, and/or depicts the scene including the school bus 210, the first vehicle 320, the second vehicle 322, and the surrounding environment.

In some aspects, the AV 102 can determine, based on the sensor data, a first distance (d₁) between the first vehicle 320 and the school bus 210, a second distance (d₂) between the second vehicle 322 and the school bus 210, a third distance (d₃) between the first vehicle 320 and the second vehicle 322, a fourth distance (d₄) between the first vehicle 320 and the curb 330, and/or a fifth distance (d₅) between the second vehicle 322 and the curb 330.

In some examples, the AV 102 can determine the behavior of the vehicle(s) (e.g., the first vehicle 320 and/or the second vehicle 322) with respect to the school bus 210 based on one or more parameters. Non-limiting examples of the parameter(s) can include the lane location, various distances associated with the school bus 210, the first vehicle 320, the second vehicle 322, and/or the curb 330 (e.g., d₁-d₅), and contextual and/or environmental factors. For example, the AV 102 can determine, based on various parameters, whether the first vehicle 320 and/or the second vehicle 322 are stopped behind the school bus 210 in response to the school bus 210 that may be active (e.g., that may have the light system 212 activated/on) or irrespective of the status of the school bus or for other reasons (e.g., to park near the curb 330). In some cases, the AV 102 may determine the behavior of the first vehicle 320 with respect to the school bus 210 in a similar manner as illustrated in FIG. 2, for example, based on the first distance (d₁) between the first vehicle 320 and the school bus 210, a fourth distance (d₄) between the first vehicle 320 and the curb 330, and/or contextual or environmental factors.

In some examples, the AV 102 may determine the behavior of the second vehicle 322 with respect to the school bus 210. Additionally or alternatively, the AV 102 may determine whether the second vehicle 322 is stopped behind the first vehicle 320, which may be stopped in response to an active state of the school bus 210, or whether the second vehicle 322 is stopped irrespective of the status of the school bus 210 and/or the first vehicle 320 (e.g., for other reasons such as to park). For example, if the distance (d₃) between the first vehicle 320 and the second vehicle 322 is below a threshold distance or within a threshold range, the AV 102 can determine that the second vehicle 322 is stopped in response to the active school bus 210. In another example, if the distance between the first vehicle 320 and the second vehicle 322 exceeds a threshold distance or is out of a threshold range, the AV 102 can determine that the second vehicle 322 is stopped for other reasons (e.g., for parking).

In some cases, the AV 102 may determine whether the second vehicle 322 is stopped to park in an area associated with the curb 330 irrespective of the status of the school bus 210 or the first vehicle 320. For example, if the distance (d₅) between the second vehicle 322 and the curb 330 is below a threshold distance or within a threshold range, the AV 102 can determine that the second vehicle 322 is stopped to park near the curb 330.

In some examples, based on the determined behavior of the vehicle(s) (e.g., the first vehicle 320 and the second vehicle 322) with respect to the school bus 210, the AV 102 can determine or plan controlling of the AV 102. For example, if the first vehicle 320 is stopped in response to an active state of the school bus 210 and the second vehicle 322 is stopped to park near the curb 330, the AV 102 can determine whether there is enough space for the AV 102 to drive in between the first vehicle 320 and the second vehicle 322 based on the distance (d₃) between the first vehicle 320 and the second vehicle 322. As such, the AV 102 can pass the second vehicle 322 that is parked near the curb 330 and stop behind the first vehicle 320 until the school bus 210 starts moving.

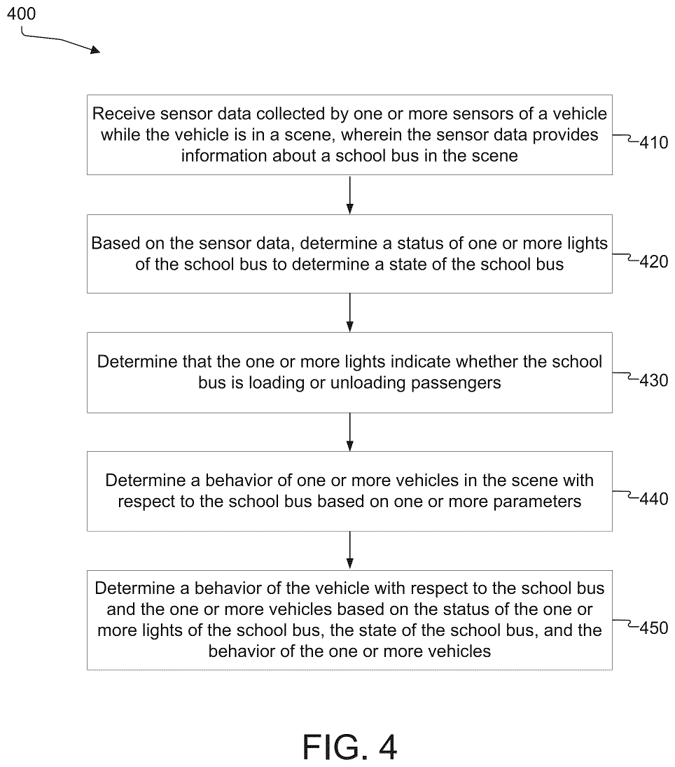

FIG. 4 is a flowchart illustrating an example process 400 for detecting a school bus in a scene and responding to a state/status of the school bus. Although the example process 400 depicts a particular sequence of operations, the sequence may be altered without departing from the scope of the present disclosure. For example, some of the operations depicted may be performed in parallel or in a different sequence that does not materially affect the function of process 400. In other examples, different components of an example device or system that implements process 400 may perform functions at substantially the same time or in a specific sequence.

At block 410, the process 400 can include receiving sensor data collected by one or more sensors (e.g., sensor system 104, sensor system 106, sensor system 108) of a vehicle (e.g., AV 102) while the vehicle is in a scene. For example, the AV 102 (e.g., the perception stack 112 as illustrated in FIG. 1) can receive sensor data collected by various sensors (e.g., sensor systems 104-108 as described in FIG. 1) of the AV 102. The sensor data can include, for example, camera data, image data, LiDAR data, RADAR data, IR data, and/or any other data that are captured by sensors of the AV 102.

In some examples, the sensor data can provide information and/or cues about a school bus in the scene, such as information and/or cues about a state of the school bus in the scene. For example, the sensor data collected by sensor(s) of the AV 102 can include sensor data that measures, describes, and/or depicts the school bus 210 in the scene and/or any attribute, behavior, condition, and/or property of the school bus 210 in the scene. In some cases, the sensor data can provide information and/or cues about the school bus 210 such as size, dimensions, color, pose, motion (or lack thereof), location, and/or any other attributes associated with the school bus 210. The sensor data can additionally or alternatively provide information and/or cues about one or more components of the school bus and/or one or more vehicles in the scene. For example, the sensor data can provide information and/or cues about a status of a light system of the school bus (e.g., statically displaying a light having a particular color and/or characteristic, displaying a pattern of light (e.g., flashing a light, etc.), not displaying any lights and/or any patterns of lights, etc.), a status of a stop signal device of the school bus (e.g., an extended state of an arm with a stop sign mounted on the school bus, a protracted state of the arm with the stop sign, etc.), a status of brake lights of the school bus, a pose of one or more vehicles relative to the school bus and/or a curb within a proximity to a lane/road of the school bus, a motion (or lack thereof) of one or more vehicles relative to the school bus, a proximity of the one or more vehicles to a curb adjacent to a lane/road of the one or more vehicles and/or the school bus, a location of the one or more vehicles within the scene or a road in the scene, a behavior of the one or more vehicles (e.g., parked, passing the school bus, stopped behind the school bus, etc.), etc.

At block 420, the process 400 can include based on the sensor data, determining a status of one or more lights of the school bus to determine a state of the school bus. For example, the AV 102 can determine, based on the sensor data, the status of a light system (e.g., light system 212) of the school bus 210, such as whether one or more lights of the light system are being displayed/emitted and/or are flashing. The AV 102 can predict a state of the school bus based on the status of the light system and/or classify the state of the school bus accordingly. For example, if the AV 102 determines, based on the sensor data, that the one or more lights on the light system of the school bus being displayed/emitted or are flashing, the AV 102 can determine that the light system 212 is on/activated and classify the state of the school bus 210 as active (e.g., loading or unloading passengers). If the lights on the light system 212 are not displayed/emitted or flashing, the AV 102 can determine that the light system 212 is off/deactivated and classify the state of the school bus 210 as inactive.

In some aspects, the process 400 can include additionally or alternatively using one or more other cues, such as contextual information and/or cues, to determine the status of the school bus. Examples of other cues can include, without limitation, road features (e.g., traffic signs, curbs, sidewalks, etc.), lane geometries, a presence of one or more people and/or predicted passengers (e.g., children) within a threshold proximity to the school bus, a behavior (e.g., congregating or waiting in place, sitting, gesturing in a direction of the school bus, moving, etc.) of one or more people (e.g., children, adults associated with the children, etc.) within a proximity to the school bus or a school bus stop, etc. For example, if the status of the school bus 210 cannot be determined based on the sensor data (e.g., due to an obstructed view of one or more camera sensors of the school bus, an occlusion at least partly blocking a view of the sensors of the AV 102 to the school bus and/or a light system of the school bus, the school bus and/or a light system of the school bus being outside of a field-of-view of sensors of the AV 102, etc.), the AV 102 can use the sensor data to determine other cues (e.g., contextual information, etc.) about the scene or the surrounding environment and use such cues to determine the status of the school bus 210. For example, if the sensor data reflects that children are getting on or off the school bus 210 or the stop-sign arm on the school bus 210 is extended outward relative to the school bus, the AV 102 can determine that the status of the school bus 210 is active (e.g., and that the light system 212 may be activated).

At block 430, the process 400 can include determining that the one or more lights indicate whether the school bus is loading or unloading passengers. For example, the AV 102 can determine that the one or more lights are associated with the light system 212 that is used to provide an alert to others in the scene in regard to loading or unloading one or more people and/or predicted passengers (e.g., children).

At block 440, the process 400 can include determining a behavior of one or more vehicles with respect to the school bus in the scene based on one or more parameters. For example, the AV 102 (e.g., the perception stack 112 as illustrated in FIG. 1) can identify, based on the sensor data, one or more vehicles (e.g., the first vehicle 220 and the second vehicle 222 as illustrated in FIG. 2 and/or the first vehicle 320 and the second vehicle 322 as illustrated in FIG. 3) located within a proximity (and/or within a proximity range) to the school bus (e.g., the school bus 210). In some examples, the process 400 can include determining and/or predicting a behavior of the one or more vehicles (e.g., the first vehicle 220 and/or the second vehicle 222 in FIG. 2 or the first vehicle 320 and/or the second vehicle 322 in FIG. 3) based on one or more parameters determined based on the sensor data. Non-limiting examples of the one or more parameters can include the location of one or more lanes of the one or more vehicles, a distance between each of the one or more vehicles and the school bus 210, a distance between each of the one or more vehicles and a curb (e.g., curb 230 or 330) that is adjacent to the one or more vehicles, a pose of the one or more vehicles relative to the school bus 210, a motion (or lack thereof) of the one or more vehicles, a distance/proximity of the one or more vehicles to one or more scene elements (e.g., a parking meter, a marked parking spot, an intersection, a crosswalk, a traffic sign, etc.), one or more lights of the one or more vehicles (e.g., brake lights, etc.), and contextual and/or environmental factors.

For example, if the distance between a vehicle (e.g., the first vehicle 220 or the second vehicle 222 in FIG. 2 or the first vehicle 320 or the second vehicle 322 in FIG. 3) and the school bus 210 is below a threshold distance, the AV 102 can determine that the vehicle is stopped in response to the school bus 210, which may have a light system activated. In another example, if the distance between the vehicle and a curb (e.g., curb 230 or 330) is below a threshold distance, the AV 102 can determine that the vehicle is stopped to park in an area associated with the curb irrespective of the status of the school bus 210. In another example, if the AV 102 determines that the vehicle is within road markings corresponding to a parking spot on the road, the AV 102 can determine that the vehicle is stopped to park irrespective of the status of the school bus 210.

In some examples, the process 400 can include, in response to determining that the status of the one or more lights of the school bus is unknown, determining to use other information or cues associated with the scene to determine the state of the school bus. For example, if the sensors of the AV 102 do not have a clear view of the light system of the school bus (e.g., the light system 212 is not within a field-of-view of the light system) to determine whether the lights are displayed/emitted or flashing, the AV 102 can determine that the status of the light system (e.g., light system 212) is unknown, in which case the AV 102 may need to look at the behavior of other vehicles in the scene (e.g., the first vehicle 220 or the second vehicle 222 in FIG. 2 or the first vehicle 320 or the second vehicle 322 in FIG. 3), which is determined as described above.

At block 450, the process 400 can include determining a behavior of the vehicle (e.g., AV 102) with respect to the school bus and the one or more vehicles based on the status of the one or more lights of the school bus, the state of the school bus, and the behavior of the one or more vehicles. For example, the state of the school bus, the status of the one or more lights of the school bus, and/or the behavior of the vehicle(s) can be provided to the planning stack 118 so that the AV 102 can respond depending on a state of the school bus 210 (e.g., active or inactive) and/or a state of a light system of the school bus 210 (e.g., activated/on, deactivated/off).

In some examples, determining the behavior of the vehicle (e.g., AV 102) can include generating a signal instructing the vehicle (e.g., AV 102) to stop behind at least one of the school bus and the one or more vehicles based on a determination that the state of the school bus comprises loading or unloading one or more passengers. In some cases, the signal can instruct the vehicle to maneuver around the school bus based on a determination that the state of the school bus does not comprise loading or unloading the one or more passengers. For example, if the AV 102 determines that the school bus 210 is active (e.g., the light system 212 is activated/on) and the one or more vehicles (e.g., the first vehicle 220) are located behind the school bus 210 and predicted to be stopped in response to the active state of the school bus 210, the AV 102 may determine to stop behind the one or more vehicles and wait until the school bus 210 starts moving. In another example, if the AV 102 determines that the school bus 210 is active (e.g., the light system 212 is activated/on) and the one or more vehicles (e.g., the first vehicle 220) are located behind the school bus 210 but predicted to be parked irrespective of the status of the school bus 210, the AV 102 may determine to wait behind the vehicle(s) (e.g., the first vehicle 220) until the status of the school bus 210 changes and starts moving or to pass the vehicle(s) (e.g., the first vehicle 220) and stop and wait behind the school bus 210 and in front of the vehicle(s) (e.g., the first vehicle 220) depending on the distance between the school bus 210 and the vehicle(s) (e.g., the first vehicle 220).

In some aspects, machine learning algorithms can be used to identify a school bus in a scene, determine the status of the school bus (e.g., based on one or more cues such as a status of a light system mounted on the school bus, etc.), and determine/predict the behavior of other vehicle(s) in the scene that are located within a proximity to (or a proximity range) the school bus. For example, the AV 102 (e.g., via local computing device 110 as illustrated in FIG. 1 or machine learning algorithm via deep learning neural network 500 as illustrated in FIG. 5) may detect the school bus 210 or vehicles 220, 222, 320, 322 located within proximity to the AV 102, determine the status of the school bus 210, and determine/reason the behavior of the vehicles 220, 222, 320, 322 as illustrated in FIGS. 2 and 3.

In FIG. 5, the disclosure now turns to a further discussion of models that can be used by the systems and techniques described herein and/or to implement the systems and techniques described herein. FIG. 5 is an example of a deep learning neural network 500 that can be used to implement all or a portion of the systems and techniques described herein (e.g., neural network 500 can be used to implement a perception module (or perception system) as discussed above). In another example, neural network 500 located on an AV (e.g., AV 102) may include machine learning algorithms configured to detect a school bus (e.g., school bus 210), determine a status of the school bus (e.g., whether the light system 212 is activated or not), and/or determine a behavior of one or more vehicles located within a proximity to the school bus (e.g., whether first vehicle 320 or second vehicle 322 is stopped/waiting for an active school bus 210 or parked irrespective of the status of school bus 210).

In some examples, an input layer 520 can be configured to receive sensor data and/or data relating to an environment surrounding an AV. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\acute{ } 2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communication interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some examples, a hardware service that performs a particular function can include the software component stored in a computer-readable medium in connection with the necessary hardware components, such as processor 610, connection 605, output device 635, etc., to carry out the function.

Examples within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: receive sensor data collected by one or more sensors of a vehicle while the vehicle is in a scene, wherein the sensor data provides information about a school bus in the scene; based on the sensor data, determine a status of one or more lights of the school bus to determine a state of the school bus; determine that the one or more lights indicate whether the school bus is loading or unloading passengers; determine a behavior of one or more vehicles in the scene with respect to the school bus based on one or more parameters; and determine a behavior of the vehicle with respect to the school bus and the one or more vehicles based on the status of the one or more lights of the school bus, the state of the school bus, and the behavior of the one or more vehicles.

Aspect 2. The system of Aspect 1, wherein the one or more processors are configured to: in response to determining that the status of the one or more lights of the school bus is unknown, determine to use the behavior of the one or more vehicles with respect to the school bus to determine the behavior of the vehicle.

Aspect 3. The system of Aspect 1 or 2, wherein determining the state of the school bus is based on contextual information comprising at least one of a lane geometry of a lane in the scene, a road feature of a road in the scene, and a presence of one or more passengers within a threshold proximity to the school bus.

Aspect 4. The system of any of Aspects 1 to 3, wherein the one or more parameters include a distance between the one or more vehicles and the school bus.

Aspect 5. The system of Aspect 4, wherein the one or more processors are configured to: in response to determining that the distance between the one or more vehicles and the school bus is below a threshold, determine that the one or more vehicles are stopped for the school bus.

Aspect 6. The system of any of Aspects 1 to 5, wherein the one or more parameters include a distance between each of the one or more vehicles and a curb adjacent to the one or more vehicles.

Aspect 7. The system of Aspect 6, wherein the one or more processors are configured to: in response to determining that the distance between each of the one or more vehicles and the curb is below a threshold, determine that the one or more vehicles are stopped to park in an area associated with the curb.

Aspect 8. The system of any of Aspects 1 to 7, determining the behavior of the vehicle comprises generating a signal instructing the vehicle to: stop behind at least one of the school bus and the one or more vehicles based on a determination that the state of the school bus comprises loading or unloading one or more passengers; or maneuver around the school bus based on a determination that the state of the school bus does not comprise loading or unloading the one or more passengers.

Aspect 9. The system of any of Aspects 1 to 8, wherein the one or more processors are configured to: determine whether a first distance between the one or more vehicles and the school bus is within a first range; and determine whether a second distance between each of the one or more vehicles and a curb adjacent to the one or more vehicles is within a second range.

Aspect 10. The system of Aspect 9, wherein the one or more processors are configured to: in response to determining that the first distance is within the first range and the second distance is within the second range, determine that the one or more vehicles are stopped for the school bus.

Aspect 11. The system of any of Aspects 1 to 10, wherein the one or more processors are configured to: based on the sensor data, determine a status of a stop-sign device mounted on the school bus.

Aspect 12. The system of any of Aspects 1 to 11, wherein the state of the school bus comprises at least one of an active state with respect to loading or unloading one or more passengers of the school bus, an inactive state with respect to loading or unloading the one or more passengers, and an unknown state with respect to loading or unloading the one or more passengers.

Aspect 13. A method comprising: receiving sensor data collected by one or more sensors of a vehicle while the vehicle is in a scene, wherein the sensor data provides information about a school bus in the scene; based on the sensor data, determining a status of one or more lights of the school bus to determine a state of the school bus; determining that the one or more lights indicate whether the school bus is loading or unloading passengers; determining a behavior of one or more vehicles in the scene with respect to the school bus based on one or more parameters; and determining a behavior of the vehicle with respect to the school bus and the one or more vehicles based on the status of the one or more lights of the school bus, the state of the school bus, and the behavior of the one or more vehicles.

Aspect 14. The method of Aspect 13, further comprising: in response to determining that the status of the one or more lights of the school bus is unknown, determining to use the behavior of the one or more vehicles with respect to the school bus to determine the behavior of the vehicle.

Aspect 15. The method of Aspect 13 or 14, wherein determining the state of the school bus is based on contextual information comprising at least one of a lane geometry of a lane in the scene, a road feature of a road in the scene, and a presence of one or more passengers within a threshold proximity to the school bus.

Aspect 16. The method of any of Aspects 13 to 15, wherein the one or more parameters include a distance between the one or more vehicles and the school bus.

Aspect 17. The method of Aspect 16, further comprising: in response to determining that the distance between the one or more vehicles and the school bus is below a threshold, determining that the one or more vehicles are stopped for the school bus.

Aspect 18. The method of any of Aspects 13 to 17, wherein the one or more parameters include a distance between each of the one or more vehicles and a curb adjacent to the one or more vehicles.

Aspect 19. The method of Aspect 18, further comprising: in response to determining that the distance between each of the one or more vehicles and the curb is below a threshold, determining that the one or more vehicles are stopped to park in an area associated with the curb.

Aspect 20. The method of any of Aspects 13 to 19, wherein determining the behavior of the vehicle comprises generating a signal instructing the vehicle to: stop behind at least one of the school bus and the one or more vehicles based on a determination that the state of the school bus comprises loading or unloading one or more passengers; or maneuver around the school bus based on a determination that the state of the school bus does not comprise loading or unloading the one or more passengers.

Aspect 21. The method of Aspects 13 to 20, further comprising: determining whether a first distance between the one or more vehicles and the school bus is within a first range; and determining whether a second distance between each of the one or more vehicles and a curb adjacent to the one or more vehicles is within a second range.

Aspect 22. The method of Aspect 21, further comprising: in response to determining that the first distance is within the first range and the second distance is within the second range, determining that the one or more vehicles are stopped for the school bus.

Aspect 23. The method of any of Aspects 13 to 22, wherein the one or more processors are configured to: based on the sensor data, determine a status of a stop-sign device mounted on the school bus.

Aspect 24. The method of any of Aspects 13 to 23, wherein the state of the school bus comprises at least one of an active state with respect to loading or unloading one or more passengers of the school bus, an inactive state with respect to loading or unloading the one or more passengers, and an unknown state with respect to loading or unloading the one or more passengers.

Aspect 25. The non-transitory computer-readable medium having stored thereon instructions which, when executed by one or more processors, cause the one or more processors to perform a method according to any of Aspects 13 to 24.

Aspect 26. A system comprising means for performing a method according to any of Aspects 13 to 24.

Aspect 27. The system of Aspect 26, wherein the system comprises an autonomous vehicle.

Aspect 28. A computer-program product including instructions which, when executed by one or more processors, cause the one or more processors to perform a method according to any of Aspects 13 to 24.

What is claimed is:

1. A system comprising:
a memory; and
one or more processors coupled to the memory, the one or more processors being configured to:
receive sensor data collected by one or more sensors of a vehicle while the vehicle is in a scene, wherein the sensor data provides information about a school bus in the scene;
based on the sensor data, determine a status of one or more lights of the school bus to determine a state of the school bus;
determine that the one or more lights indicate whether the school bus is loading or unloading passengers;
determine a behavior of one or more vehicles in the scene with respect to the school bus based on one or more parameters; and
determine a behavior of the vehicle with respect to the school bus and the one or more vehicles based on the status of the one or more lights of the school bus, the state of the school bus, and the behavior of the one or more vehicles.

2. The system of claim 1, wherein the one or more processors are configured to:
in response to determining that the status of the one or more lights of the school bus is unknown, determine to use the behavior of the one or more vehicles with respect to the school bus to determine the behavior of the vehicle.

3. The system of claim 1, wherein determining the state of the school bus is based on contextual information comprising at least one of a lane geometry of a lane in the scene, a road feature of a road in the scene, and a presence of one or more passengers within a threshold proximity to the school bus.

4. The system of claim 1, wherein the one or more parameters include a distance between the one or more vehicles and the school bus.

5. The system of claim 4, wherein the one or more processors are configured to:
in response to determining that the distance between the one or more vehicles and the school bus is below a threshold, determine that the one or more vehicles are stopped for the school bus.

6. The system of claim 1, wherein the one or more parameters include a distance between each of the one or more vehicles and a curb adjacent to the one or more vehicles.

7. The system of claim 6, wherein the one or more processors are configured to:
in response to determining that the distance between each of the one or more vehicles and the curb is below a threshold, determine that the one or more vehicles are stopped to park in an area associated with the curb.

8. The system of claim 1, determining the behavior of the vehicle comprises generating a signal instructing the vehicle to:
stop behind at least one of the school bus and the one or more vehicles based on a determination that the state of the school bus comprises loading or unloading one or more passengers; or
maneuver around the school bus based on a determination that the state of the school bus does not comprise loading or unloading the one or more passengers.

9. The system of claim 1, wherein the one or more processors are configured to:
determine whether a first distance between the one or more vehicles and the school bus is within a first range; and
determine whether a second distance between each of the one or more vehicles and a curb adjacent to the one or more vehicles is within a second range.

10. The system of claim 9, wherein the one or more processors are configured to:
in response to determining that the first distance is within the first range and the second distance is within the second range, determine that the one or more vehicles are stopped for the school bus.

11. The system of claim 1, wherein the one or more processors are configured to:
Based on the sensor data, determine a status of a stop-sign device mounted on the school bus.

12. The system of claim 1, wherein the state of the school bus comprises at least one of an active state with respect to loading or unloading one or more passengers of the school bus, an inactive state with respect to loading or unloading the one or more passengers, and an unknown state with respect to loading or unloading the one or more passengers.

13. A method comprising:
receiving sensor data collected by one or more sensors of a vehicle while the vehicle is in a scene, wherein the sensor data provides information about a school bus in the scene;
based on the sensor data, determining a status of one or more lights of the school bus to determine a state of the school bus;
determining that the one or more lights indicate whether the school bus is loading or unloading passengers;
determining a behavior of one or more vehicles in the scene with respect to the school bus based on one or more parameters; and
determining a behavior of the vehicle with respect to the school bus and the one or more vehicles based on the status of the one or more lights of the school bus, the state of the school bus, and the behavior of the one or more vehicles.

14. The method of claim 13, further comprising:
in response to determining that the status of the one or more lights of the school bus is unknown, determining to use the behavior of the one or more vehicles with respect to the school bus to determine the behavior of the vehicle.

15. The method of claim 13, wherein determining the state of the school bus is based on contextual information comprising at least one of a lane geometry of a lane in the scene, a road feature of a road in the scene, and a presence of one or more passengers within a threshold proximity to the school bus.

16. The method of claim 13, wherein the one or more parameters include a distance between the one or more vehicles and the school bus.

17. The method of claim 16, further comprising:
in response to determining that the distance between the one or more vehicles and the school bus is below a threshold, determining that the one or more vehicles are stopped for the school bus.

18. The method of claim 13, wherein the one or more parameters include a distance between each of the one or more vehicles and a curb adjacent to the one or more vehicles.

19. The method of claim 18, further comprising:
in response to determining that the distance between each of the one or more vehicles and the curb is below a threshold, determining that the one or more vehicles are stopped to park in an area associated with the curb.

20. A non-transitory computer-readable medium having stored thereon instructions which, when executed by one or more processors, cause the one or more processors to:
receive sensor data collected by one or more sensors of a vehicle while the vehicle is in a scene, wherein the sensor data provides information about a school bus in the scene;
based on the sensor data, determine a status of one or more lights of the school bus to determine a state of the school bus;
determine that the one or more lights indicate whether the school bus is loading or unloading passengers;
determine a behavior of one or more vehicles in the scene with respect to the school bus based on one or more parameters; and
determine a behavior of the vehicle with respect to the school bus and the one or more vehicles based on the status of the one or more lights of the school bus, the state of the school bus, and the behavior of the one or more vehicles.
